(19) United States
(12) Patent Application Publication
(10) Pub. No.: US 2005/0182658 A1
(43) Pub. Date: Aug. 18, 2005

(54) Method of improving a clinical study

(76) Inventors: Klaus Abraham-Fuchs, Erlangen (DE); Gudrun Zahlmann, Neumarkt (DE); Eva Rumpel, Erlangen (DE); Siegfried Schneider, Erlangen (DE); Markus Schmidt, Nuernberg (DE); Horst Schreiner, Fuerth (DE)

Correspondence Address: HARNESS, DICKEY & PIERCE, P.L.C., P.O.BOX 8910, RESTON, VA, 20195, US

(21) Appl. No.: 10/975,057

(22) Filed: Oct. 28, 2004

Related U.S. Application Data
(60) Provisional application No. 60/545,168, filed on Feb. 18, 2004.

(51) Int. Cl. G06F 17/60

(52) U.S. Cl. 705/2

(57) ABSTRACT

A method is proposed for improving a clinical study. The method includes obtaining criteria for the clinical study, and comparing clinical data to the obtained criteria using a computer device. Thereafter, using the computer device, performance measures are derived based upon the comparisons. These derived performance measures are then usable to improve the clinical study. For example, these performance measures may be used for ranking, and consequently improving, the clinical study.

The present application hereby claims priority under 35 U.S.C. §119 on U.S. provisional patent application No. 60/545,168 filed Feb. 18, 2004, the entire contents of which are hereby incorporated herein by reference.

### FIELD OF THE INVENTION

The present invention is generally related to the field of clinical studies.

### BACKGROUND OF THE INVENTION

The framework for traditional business models for clinical studies has been rather stable over the last few decades. In such a business model, a sponsor (such as a pharmaceutical company which has developed a new drug, for example) paid all participants which performed in the study. At a minimum, these included participating patients and a medical doctor (an investigator) in charge of supervising the patients. In many cases, an investigation or clinical trial site (e.g., a hospital) was additionally included, where one or more investigators was employed.

So called contract research organizations (CROs) further established their services in the workflow chain of clinical studies, in between the sponsor on one end, and the investigator and patients on the other. The CRO often took over the complete management of the clinical study, including all necessary services including, for example, development of study protocol, recruiting patients and investigators and/or investigation sites, contracting the participants, supervising the conductance of the study, collecting and evaluating data, channeling the payment from the sponsor to the participants, etc. Of course, for such services, the CRO received a substantial part of the aforementioned payment for their own services.

When recruiting the patients, the CRO, or even the sponsor, tended to use and still uses crude methods wherein prospective patients fill out forms and are screened as candidates for clinical studies. The data utilized is normally that obtained from the patient himself or herself. Regarding the investigator or investigator/clinical trial site chosen to conduct/monitor/etc. the study, information previously obtained by the sponsor or CRO can be used. However, this is often a slow process which often does not produce an ideal patient, investigator or investigator/clinical trial site.

FIG. 1 illustrates a typical traditional cash flow system for use in connection with clinical studies. Initially, a sponsor 100 (such as a drug manufacturer, for example) defines the study requirements or criteria (study parameters, study protocol, etc.) for the particular clinical study in question. A CRO 120 may then be employed to manage the study, noting that the CRO 120 may develop the study requirements or criteria of the clinical study or may assist therein. The CRO may also assist in recruiting patients for the study, as well as selecting an appropriate investigator/investigators and appropriate clinical trial site(s). If a CRO is involved, the CRO is paid by the sponsor 100. The CRO then manages the study and then pays others involved in the study including investigators 130, patients 140, and potentially investigation or clinical trial sites such as hospitals, for example (not shown).

This traditional cash flow model had some flaws. For example, it did not foresee making payments dependant on the quality of delivered performances. This was mainly because it was very difficult to impossible in the past to measure the quality of performance. Therefore it was neither possible for the sponsor to save money by paying less for a performance which was more inferior than expected; nor was it possible to reward excellent performance through additional incentives.

### SUMMARY OF THE INVENTION

The present inventors have recognized problems with the traditional clinical study model, and an object of the present application is to improve on the traditional clinical study model, and thus improve the clinical study or clinical study process. One specific object involves improving cost-effectiveness of a clinical study. In one embodiment, this can include, for example, the use of clinical IT infrastructure to derive, when correlated with obtained criteria of a clinical study, performance measures for improving the clinical study. Further, the criteria for the clinical study may include at least one performance parameter, wherein performance parameter measures are derived for at least one performance parameter. The present inventors have recognized these and other needs for improving a clinical study.

Further, the inventors have recognized that in the traditional setting of a clinical study, the CROs had no access to this IT infrastructure. The investigation or clinical trial sites such as a hospital, for example, were the owner of such IT infrastructure and databases. As such, the sponsors and CROs had no such access. However, as these investigation/clinical trial sites were biased parties and thus sponsors of clinical studies and CROs were not interested in their involvement to the extent of using their IT infrastructure.

The present inventors, in one embodiment of the present invention, have recognized that further value of such clinical IT databases can be obtained when clinical data from a plurality of different investigation sites is used, especially different investigation sites participating in the same clinical study. This added value can be provided by an independent party, a Hospital IT Solution provider (HISP) who can develop, sell, install and maintain clinical IT solutions and databases, and in many cases can also store and maintain related databases obtained from a correlation of the traditional clinical IT databases and clinical study criteria.

The present inventors, in one embodiment of the present invention, also recognized the importance of the introduction of some type of quality control and benchmarking measures. By inclusion of various measures, the payment for the clinical study can be made to be performance/outcome oriented, rather than oriented as contracts for upfront fixed amounts.

An embodiment of the present application is directed to a method of improving a clinical study. The method may include obtaining criteria for the clinical study; comparing the clinical data with the obtained criteria using a computer device; and deriving, using the computer device, performance measures for improving the clinical study. These performance measures may be used for ranking, and consequently improving, the clinical study. Further, the criteria for the clinical study may include at least one performance parameter, wherein performance parameter measures are derived for at least one performance parameter.

In another embodiment, a method of improving a clinical study may include creating first electronic database of criteria for the clinical study and creating a second electronic database with rules for calculating performance measures from the criteria and from clinical data. The first and second databases and the clinical data may then be evaluated to calculate performance measures. The performance measures may then be stored in a third database and, from the third database, a ranking of the performance measures may be derived for use in improving the clinical study. Further, the criteria for the clinical study may include at least one performance parameter, wherein performance parameter measures are calculated for at least one performance parameter.

In another embodiment of the present application, a method may include creating an electronic database of rules for calculating performance measures from criteria of a clinical study and from clinical data. The performance measures may then be calculated from the database of rules, the criteria of the clinical study and the clinical data. Finally, from the performance measures, a ranking of the performance parameter measures may be derived. Further, the criteria for the clinical study may include at least one performance parameter, wherein performance parameter measures are calculated for at least one performance parameter.

Other embodiments of the present application may include devices for implementing any of the aforementioned methods, programs adapted to perform any of the aforementioned methods when executed on a computer, and/or computer readable mediums storing any of the aforementioned programs.

Additional embodiments of the present application may include apparatuses for improving a clinical study. One such apparatus, in one embodiment, may include a first electronic database including criteria for the clinical study; a second electronic database including rules for calculating performance measures from the criteria and from clinical data; a rules engine, adapted to interface with and evaluate the first and second databases and the clinical data to calculate the performance measures. Finally, a third database may then be included for storing the calculated performance measures. A ranking of the performance measures may then be derivable from the third database for use in improving the clinical study. Further, the criteria for the clinical study may include at least one performance parameter, wherein performance parameter measures are calculated for at least one performance parameter.

For a full understanding of the nature and advantages of the various aspects of the invention, reference should be made to the detailed description of exemplary embodiments taken in conjunction with the accompany drawings. The detailed description provides only exemplary embodiments of the invention and thus, the claims of the present invention should not be limited as such.

### BRIEF DESCRIPTION OF THE DRAWINGS

The present invention will become more fully understood from the detailed description of preferred exemplary embodiments given hereinbelow and the accompanying drawings, which are given by way of illustration only and are thus not limitive of the present invention, and wherein:

FIG. 1 illustrates a typical traditional cashflow business model for use in clinical studies;

FIG. 2 is an example of a first embodiment of the present application illustrating the use of a Hospital IT Solution provider (HISP);

FIG. 3 includes an exemplary embodiment of a risk sharing business model for a HISP used in connection with the clinical study;

FIG. 4 illustrates a business model for another embodiment of the present application; and

FIG. 5 illustrates an exemplary embodiment of the present application for evaluation of performance measures.

### DETAILED DESCRIPTION OF THE EXEMPLARY EMBODIMENTS OF THE PRESENT APPLICATION

In one embodiment, the present invention is directed to a method of improving clinical study, more specifically improving a business model of a clinical study utilizing clinical information technology (IT) infrastructure and then creating additional databases. In one embodiment, the method includes obtaining criteria for a clinical study, wherein the study can include a clinical study protocol, target performance parameters of the clinical study, etc. The obtained criteria and clinical data (obtained from existing clinical IT infrastructure, for example) are then compared using a computer device (a device including a processor for example). From the compared information, performance measures can then be derived. These derived performance measures can then be used for improving the clinical study (by ranking, for example). Further, the criteria for the clinical study may include at least one performance parameter, wherein performance parameter measures are derived for at least one performance parameter.

Clinical data can include data stored in a database of existing clinical IT infrastructure, such as an electronic healthcare database, for example. This can include, but is not limited to at least one of a database with electronic patient records, a database of clinical workflow management system, information from a hospital IT system (financial or clinical), information from a laboratory or radiology information system, information from a picture archiving and communication system (PACS), information from a physician's IT system, for example, etc.

In one aspect of one embodiment, information or contracts which regulate the amounts of payment upfront, between the sponsor on one side and the CRO, and/or investigator, and/or patient on the other side, may be based on organizational milestones. In the past, the clinical trial business models did not make use of clinical IT infrastructure and databases, such as electronic patient records (EPR), hospital information systems (HIS) or clinical workflow management systems. In an embodiment of the present application, such clinical IT infrastructure and databases, storing various types of clinical data, are utilized in connection with obtained criteria for the clinical study, to derive performance measures of the study, which can then be used to improve the study (and/or the clinical study business process). Further, the criteria for the clinical study may include at least one performance parameter, wherein performance parameter measures are derived for at least one performance parameter.

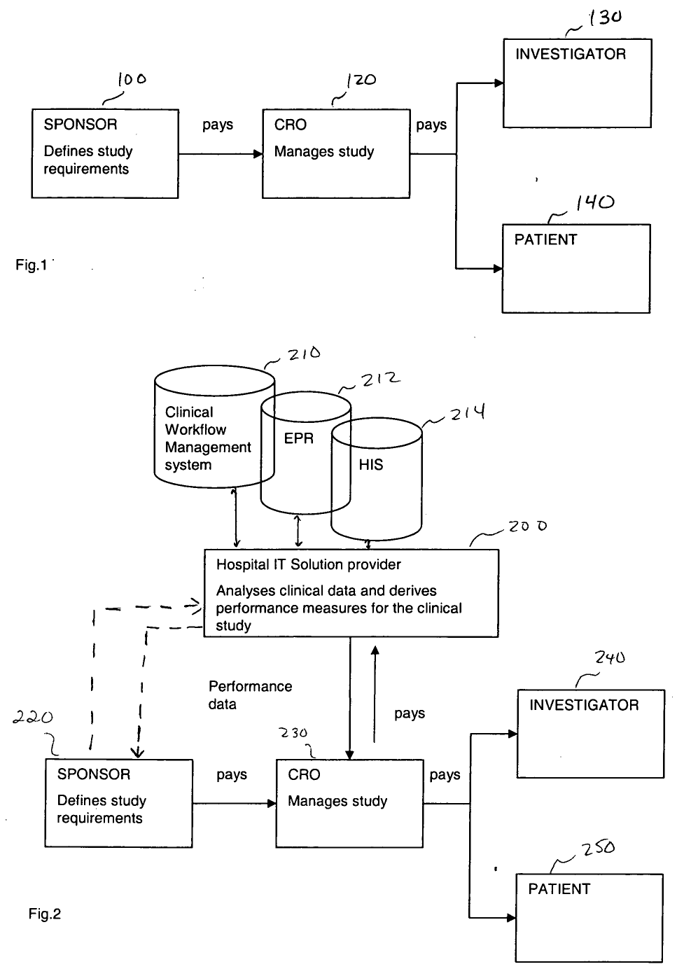

As shown in FIG. 2 of the present application, the role of a hospital IT solution provider (HISP) 200 has been introduced into the clinical study process and business model. A HISP 200, for example, develops, markets, sells and maintains software to support all types of clinical processes and the necessary IT infrastructure to run this software, i.e. computers, computer interfaces, computer networks, and mass storage devices. The term “solution provider” refers to, for example, the fact that such software and infrastructure is not sold off the shelf, without further contact to the customer after the sale. In contrast, both software and IT infrastructure is typically adapted to the customers needs and is typically maintained by the HISP 200 during a continuous service contract.

Often, such Hospital IT solutions include also the service to store and backup the huge amount of clinical data at HISP-owned mass data storage devices. Typically, the solution business also includes building a model of the customers individual clinical processes, describing this model with a computer based workflow language, and uploading this electronic workflow model into the rules engine of the clinical workflow IT.

Due to this highly interactive role of the HISP 200 in this solution provider business model, the HISP 200 often has both physical access to a considerable part of electronic clinical data, a deep understanding of his customer's clinical process, and access to the electronic model and rules engine of the clinical process. As a consequence of the electronic modeling of the clinical workflow, performance data on the workflow can be derived in an automated electronic way, and retrieved from the IT system. Since a clinical study is a special case within the general clinical workflow, it is within the scope and competence of the HISP 200 to make use of the clinical IT infrastructure described above to improve also the clinical study process.

Through his ability to access the Hospital IT (infrastructure and databases), the HISP 200 is able to analyze clinical data, such as that stored in any of the clinical workflow management system 210, EPR 212, HIS 214 (or any other type of clinical IT infrastructure and/or database). This HISP 200 connects or is otherwise networked to, and can thereby access/receive and then analyze data from any of the clinical workflow management system 210, EPR 212, HIS 214 (or any other type of clinical IT infrastructure and/or database). The HISP 200 may further be networked or otherwise connected to the sponsor 220 and/or the CRO 230. The HISP 200 then receive or otherwise obtain criteria for a clinical study from the sponsor 220 and/or CRO 230 and can then compare the obtained clinical data to (analyze in conjunction with or based upon) the obtained criteria for a clinical study. The HISP 200 of an embodiment of the present application is then able to derive performance measures for improving the clinical study from the compared information. Further, the criteria for the clinical study may include at least one performance parameter, wherein performance parameter measures are derived for at least one performance parameter.

As shown in FIG. 2, the HISP 200 can receive requirements of the clinical study directly from the sponsor 220, which can include the criteria for the clinical study; and/or can receive such information from the CRO 230 managing the study; noting that the CRO 230 may take on all necessary services for managing the study including, but not limited to development of a study protocol, recruiting patients and investigators and/or investigation or trial sites, contracting the participants, supervising the conductance of the study, collecting and evaluating the data and channeling the data from the sponsor to the participants. Thus, the CRO 230 and/or sponsor 200 may transmit information regarding desired/necessary criteria of the clinical study (and even desired target parameters) to the HISP 200. The CRO 230 and/or sponsor 200 and/or may further be involved in funneling payment to the HISP 200.

The payment to the HISP 200 may be for achieving advantages such as reduced time or cost savings or other performance parameter aspects, wherein the HISP may be involved in calculating potential advantages obtained from certain clinical trial sites/patients/investigators/etc. determined to exceed target performance parameter measures or other aspects of the obtained criteria. Clinical data of a plurality of clinical trial or investigation sites/patients/investigators/etc., and the obtained criteria, may be further analyzed or compared to determine clinical trial or investigation sites which meet or exceed target performance parameter measures of the obtained criteria and such plural patients/clinical trial sites/investigators/etc may be ranked accordingly. This ranked information can then be output or otherwise sent to the sponsor 220 and/or CRO 230 for use in determining desired patients/clinical trial sites/investigators/etc. for use in the study and the HISP 200 can then be paid or contracted for some portion of savings projected and/or achieved. Finally, the CRO 230 may be involved in paying a portion of the money to the investigators 240, the patients 250 and/or to the investigation sites not shown. Alternatively, if the CRO 230 is not involved, the HISP 200 may be involved in making such payments.

Throughout various embodiments of the present application, reference is made to “performance parameters”. With regard to such performance parameters, these can include but are not limited to study duration, costs, study result reliability, and any other “measurable” form of value to a sponsor 220 regarding the clinical study (thus resulting in performance parameter measures, namely some “measure” of a performance parameter). Such performance parameters are very important to a clinical study and can thus result in a huge savings to the sponsor, a portion of which can thus be passed on to the HISP 200. For example, the faster the clinical study can be performed (the shorter the duration), the sooner a product (such as a drug, for example) can go to market. Each day on the market can lead to thousands and even millions of dollars. Further, if costs of the clinical study can be reduced, savings are achieved. Regarding study reliability, the more reliability can be improved, the more valuable the clinical study is and the potentially faster the drug, for example, can go to market. In addition, if poor study reliability can be detected early in a clinical trial, the study at a particular trial site for example, can be terminated quickly, again resulting in an overall savings to the sponsor 220. Such performance parameter measures can be derived and/or calculated based upon clinical study criteria which may include target performance parameter measures.

Other non-limiting examples of “performance parameters” can include, but are not limited to:
Number of patients with a given diagnosis of “criteria” having been treated by the clinical study site previously;
Number of patients with a given diagnosis of “criteria” having been enrolled in the clinical studies by the clinical study site;
Number of missing clinical examination data from the “accompanying examination criteria” from patients previously enrolled in other clinical studies (corresponding to compliance of the clinical site to do all required exams); etc.

“Criteria”, as referenced throughout the embodiments of the application, refers to clinical study criteria. These “criteria” are important aspects of the clinical study. These criteria of the study can be used by the HISP 200 to formulate desired performance parameters and then, using existing clinical data, projected performance parameter measures can be calculated for one or more patients/investigators/clinical trial sites/etc. Thus, the criteria outline key or other important aspects of the study which, when provided and correlated with clinical data, can help produce likely performance parameter measures that have an effect or importance regarding an outcome of the study (effect on time to perform the study, cost of the study, etc.).

Some non-limiting examples of “criteria”, which may influence or help to determine performance parameters/performance parameter measures or other clinical study measures positively may include, but are not limited to:
Number of patients needed for the clinical study;
Patient inclusion criteria such as, for example, patients with a given diagnosis (e.g., diabetes type I, for example). Another example of patient inclusion criteria can be, for example, age group (e.g., 40-60 years) of patients to be included in the study;
Patient exclusion criteria: Patients not previously diagnosed with an ailment, (hypertension, for example). Another example of patient inclusion criteria can be, for example, patients not having been prescribed with a given medication “x” previously;
Accompanying exams to be undertaken during the study (aside from prescribing the medication under study) to the patient: This can include, but is not limited to regular (i.e., weekly, daily, etc.) control of blood pressure, heart rate, etc.; Making diagnostic images for the therapy success control every “x” days/months/years; etc.

Often, elements relating to this “criteria” cannot be measured directly, but must be deduced from other measurable parameters or clinical data, and perhaps from a combination of other measurable parameters or other measurable clinical data. Thus, the HISP 200 can, for example, build an empirical database for use in such situations. As one example, such a database can be built based on, for example, typical “dropout” rates of patients (i.e. percentage of patients who discontinue participation in the study before the scheduled termination of the study), wherein these rates might vary with investigation sites, patient age, geography, etc. Thus, the HISP 200 can create a type of mathematical formula or weighting factors regarding the combining of several direct and indirect aspects of the criteria into a prediction of probable benefit, such as probable financial benefit. Most likely, this formula will include a weighted sum or weighted product of several single criteria. This can then be correlated with existing clinical data from the clinical IT infrastructure to derive performance measures or performance parameter measures if the criteria includes performance parameters. Thereafter, an output ranking may be derived from the calculated/derived performance measures, the ranking being based upon weighted determinations using the weighing factors. The ranking can be for any or all of the parameters, and can be for any of single or multiple patients/clinical trial sites/investigators/etc.

As a result, information is available as to which clinical trial site, investigator or patient group performed best in an actual and/or recent clinical study. Performance may be measured as overall performance, averaging across a combination of several criteria for example; as a performance with respect to a specific criterion, etc.

It should be further noted that a level of guarantee of performance for at least one of a plurality of clinical trial sites, for a clinical trial for example, may be provided based on calculated performance measures. A plurality of varying levels of guarantee may be provided for a plurality of clinical trial sites. These levels of guarantees may be based, for example, upon weighted determinations, wherein weighting factors may include one of time for performing a clinical trial, quality, geographic location, etc., factors important to the sponsor 220/CRO 230 in obtaining fast and accurate results for the study.

The assignee of the present application has further been involved in various other inventions regarding clinical studies, and in some cases the use of clinical IT infrastructure, in order to improve the development of clinical study business models and/or the development of clinical study protocols; improving the effectiveness of patient recruiting; controlling the compliance of clinical study protocol rules; etc. The entire contents of each of the following applications is hereby incorporated by reference in the present application:
“Procedure to Identify Eligible Study Patients in an All-Day Setting” (U.S. provisional application Ser. No. 60/545,169, filed Feb. 18, 2004) and corresponding U.S. non-provisional application entitled “A Method Of Recruiting Patients For A Clinical Study”, assigned U.S. application Ser. No ______, and filed on Oct. 28, 2004;
“Incentive-System for Clinical Trials” (U.S. provisional application Ser. No. 60/545,170, filed Feb. 18, 2004), and corresponding U.S. non-provisional application entitled “A Method Of Monitoring Patient Participation In A Clinical Study”, assigned U.S. application Ser. No. ______, and filed on Oct. 28, 2004;
“Procedure Providing a Benchmarking of Clinical Test Sites and a Concomitant Method of Quality-Based Monetary Compensation”; (U.S. provisional application Ser. No. 60/545,165, filed Feb. 18, 2004) and corresponding U.S. non-provisional application entitled “A Method Of Examining A Plurality Of Sites for A Clinical Trial”, assigned U.S. application Ser. No. ______, and filed on Oct. 28, 2004;
“Risk-Sharing Business Model for the Use of HIS Data to Improve Cost Effectiveness of Clinical Studies” (U.S. provisional application Ser. No. 60/545,168, filed Feb. 18, 2004) and corresponding U.S. non-provisional application entitled “A Method Of Improving A Clinical Study”, assigned U.S. application Ser. No. ______, and filed on Oct. 28, 2004;
“Quality Compliance Improvement in Clinical Studies using IT-Based Clinical Workflow Systems” (U.S. provisional application Ser. No. 60/545,164, filed Feb. 18, 2004) and corresponding U.S. non-provisional application entitled “Method and System For Measuring Quality of Performance and/or Compliance with Protocol of a Clinical Study”, assigned U.S. application Ser. No. ______, and filed on Oct. 28, 2004;
Verfahren zur Durchführung einer klinischen Studie (DE 10 2004 008 196.4);
Verfahren zur Überprüfung der Durchführbarkeit eines medizinischen Vorhabens mit Aufnahmekriterien für Patienten (DE 10 2004 008 189.1);
Verfahren zur Qualitütskontrolle von je an unterschiedlichen, aber vergleichbaren Patientenkollektiven im Rahmen eines medizinischen Vorhabens erhobenen medizinischen Datensätzen (DE 10 2004 008 197.2);
Verfahren und Einrichtung zur Überprüfung der Einhaltung einer Durchführungsvorschrift für eine an einem Patienten durchgeführte medizinische MaBnahme (DE 10 2004 008 190.5);
Verfahren zur Qualitätsbewertung von elektronisch gespeicherten, insbesondere medizinischen, Wissensdaten (DE 10 2004 008 191.3);
Verfahren zur Auswahl eines möglichen Teilnehmers für ein medizinisches Vorhaben anhand eines Auswahlkriteriums (DE 10 2004 008 192.1);
Verfahren und Informationssystem zur Durchführung einer klinischen Studie an einem Patienten. (DE 10 2004 008 194.8);
Verfahren zur Überprüfung der Einhaltung einer einem medizinischen Arbeitsablauf zugeordneten Durchführungsvorschrift (DE 10 2004 008 195.6); and
Verfahren zur Auswahl eines Teilnehmers für ein medizinisches Vorhaben mit Auswahlkriterien für Patienten (DE 10 2004 008 188.3).

Thus, as such, the HISP 200 acts as an additional service party in the workflow chain and adds value in the chain of a clinical study utilizing clinical IT infrastructure and databases such as EPR 212, HIS 214, clinical workflow management system 210, etc. in an advantageous way. As such, payment and cashflow for a clinical study may be performance and outcome dependent.

In one embodiment of the present invention, further value of such clinical IT databases has been realized, wherein clinical data from a plurality of different investigation sites is used, especially different investigation sites participating in the same clinical study. This information adds to the value that can be provided by HISP 200 in FIG. 2 who can develop, sell, install and maintain clinical IT solutions and databases, and in many cases can also store and maintain related databases obtained from a correlation of the traditional clinical IT databases and clinical study criteria.

Thus, it should be understood that FIG. 2, and each of the figures and embodiments of the present application, represents the HISP 200 with access to the clinical workflow management system 210, an EPR 212 and/or an HIS 214 of one, or of a plurality of clinical trial sites. Thus, the clinical data can include data from a plurality of clinical trial sites, and further can include data from a plurality of previously conducted clinical trials. Clinical data from a plurality of clinical trial sites is thereby preferably further analyzed in conjunction with, or compared to the obtained criteria for a clinical study, to determine clinical trial sites which may provide excellent performance measures/performance parameter measures and/or exceed certain target performance parameter measures of the obtained criteria (such as target performance parameter measures, for examples). When such an analysis, comparison or determination is made, names of clinical trial sites, determined to exceed target performance parameter measures of the obtained clinical study criteria, can then be provided to the sponsor 220 and/or can be ranked accordingly. In addition, such names may be provided based upon or in accordance with a ranking.

Stated another way, the method may include further deriving/producing/outputting, from the derived performance measures/performance parameter measures, a ranking of the performance measures/performance parameter measures. The ranking may be for at least one of clinical trial sites, payment amounts and/or other things, such as study discontinuation decisions, suitability of patients for the clinical study, etc. for example. The names of clinical trial sites, determined from the rankings, can then be output to a sponsor who can then make a decision as to which patients are best suited to a study, which clinical investigation or trial sites are best suited to conduct a particular clinical study, etc.

Thus, from performance measures/performance parameter measures, a ranking of the performance measures/performance parameter measures can be derived. The ranking can include suitability of patients for the clinical study, as mentioned above. The phrase “suitability of patients for this clinical study” can be defined as follows.

The clinical study protocol also may contain a subset of criteria which define suitability of patients. This can include for example, but is not limited to: suitable patients being those which, for example, have been diagnosed for a certain disease at least 2 years and no more than 5 years ago; are between the ages of 40 and 60; patients within a distance not exceeding 20 miles from the clinical trial site. Using suitable weighting factors, from criteria, a “suitability score”, ranging e.g. from 0 . . . 100%, can be calculated. For example, a patient of age 50, living 2 miles from the clinical trial site and having been diagnosed 3 years ago, has a ranking of 100%; whereas a patient living 30 miles away, having been diagnosed 5 years ago, and being of age 60 receives a 30% suitability score ranking.

Such rankings/results provide potential savings to the sponsor 220, which can be calculated/estimated from the derived performance measures, and a portion of this potential savings can then be paid/contracted to the HISP 200. The potential savings can be calculated from using the clinical trial sites determined to exceed target performance parameter measures of the obtained criteria. Thereafter, the HISP can be paid and/or contracted for performance of the clinical study based upon the calculated potential savings. The potential savings can include any type of potential advantages, for example, at least one of reduced time and cost savings.

Thus, the HISP 200 can act, based upon calculated potential advantages or potential savings, including at least one of reduced time and cost savings, for example, as an entity who can be contracted on a risk-sharing basis. The HISP 200 can be contracted for performance of the clinical study based upon the calculated potential savings on a risk-sharing basis, based upon at least one of the potential advantages. As such, payment can be contracted or based upon the calculated potential savings, with the payment being based upon a percentage of the achieved savings. This payment/contacting can be made directly from/with the sponsor 220, or from/with the CRO 230, for example.

As previously stated, the HISP 200 can have direct access to the clinical data from one or a plurality of clinical studies, from one or a plurality of investigation clinical trial sites, including access to information in at least one electronic healthcare databases such as a clinical workflow management system 210; EPR 212; and/or HIS 214. However, indirect access to this data can also be provided through the HISP 200, wherein the HISP 200 can then perform an analysis of the clinical data using the obtained criteria for the clinical study (performing a comparison of data and criteria for example), to derive performance measures/performance parameter measures for improving the clinical study. The information regarding the specifics of the clinical study can come from the sponsor 220 or from the CRO 230.

An advantage that the HISP 200 can offer, is access to clinical data such as patient data, clinical workflow data, etc., much earlier than the CRO 230, who receives only bundled data in the form, typically, of milestone reports. A HISP 200 has access to the relevant clinical data in real time, and can extract and update all information on study-relevant clinical data such as patient data, on a daily basis for example. To this end, the HISP 200 can also incorporate new software modules in a clinical workflow management system 210, new data entries in the EPR database 212, etc., in order to specifically collect information on a clinical study. With the use of such real-time data, a much more effective monitoring of the clinical study partners and the achievement of clinical study milestones is possible.

For services of achieving or calculating some potential savings, the HISP 200 may be reimbursed with a certain percentage from the total budget for a clinical study. The cost for a clinical study essentially depends on many factors, including but not limited to the duration of the study, the number of participating patients, etc. Additionally, the last day that it takes for the study to be performed, namely for the reduced time of the study or for each day saved, a particular drug on which this study is based may be on the market one day earlier. Thus, time saving for performing the clinical study is very important to the sponsor and has a tremendous impact on the turnover of the sponsor.

In a more defined business model, the HISP 200 may choose to offer services on a risk sharing basis in a number of ways, including but not limited to the following:
“The study protocol, the contract of the sponsor 220 with the CRO 230, may contain numbers such as a budget for the study, a target duration of the study, a target number of participating patients, and a target threshold for the desired statistical significance of the study result (clinical outcome, etc.);
“The HISP 200 may analyze these numbers, and calculate from his own experience, what percentage he is able to reduce/improve these numbers.”
“The HISP 200 may calculate a cash equivalent of cost reduction for the study and/or turnover increase through earlier market start for the sponsor 220;
“The HISP 200 may offer its services to the sponsor 220, based on a certain percentage (e.g., 30%) of the cost savings/turnover increase; for whatever amount the study budget is reduced or the turnover increased by an earlier market start; then, as compared to the target values in the study protocol/contract, the HISP 200 receives the negotiated percentage of this savings as a reimbursement for his services.”

In an analogous way, the HISP 200 may contract on a risk-sharing basis for the service to accrue patients for a study. The HISP 200 may use the access to the critical IT infrastructure, including but not limited to the clinical workflow management system 210, the EPR 12, the HIS 214, etc. of one or a plurality of clinical study/investigation sites, to identify potential participants. The HISP 200 may then be reimbursed for the number of patients actually contracted, and/or for reducing the time taken to begin the study, as compared with a target value or other parameters for beginning the study as can be found in the study profile (contract) or other criteria obtained regarding the study. Overall, cost effectiveness of the clinical study can be improved by offering services which derive different types of benchmarking and performance criteria from criteria of the clinical study analyzed in conjunction with clinical IT infrastructure, such as information from hospital IT databases (which may taken from multiple investigation/clinical trial sites). Payments can be made the clinical study participants and to the HISP 200 itself within this criteria. Optionally, the HISP 200 can make its own payments pending on the outcome of the study and the risk-shared model.

In an embodiment of the application, the method of improving the clinical study, includes creating a first electronic database of criteria for the clinical study and creating a second electronic database of rules for calculating performance measures from the criteria and clinical data. Thereafter, the first and second databases and the clinical data is evaluated to calculate the performance measures. The performance measures are then stored in a third database and from the third database, a ranking of the performance measures is derived for use in improving the clinical study. Further, the criteria for the clinical study may include at least one performance parameter, wherein performance parameter measures are derived for at least one performance parameter.

In one embodiment, a first electronic database is built by the HISP 200. This database is built from criteria for the clinical study (rules, values, thresholds, etc.) either automatically or manually, extracting this information from a clinical study protocol for example. This clinical study protocol can be provided directly from the sponsor 220 or can be provided from the CRO 230 based upon the defined clinical study requirements provided by the sponsor 220.

A second electronic database may then created by the HISP 200 with rules on how to calculate performance measures from the criteria and from clinical data. Again, the clinical data can be obtained from an electronic healthcare database, such as a clinical workflow management system 210, an EPR 212 and/or the HIS 214, etc. The criteria can include various target performance parameter measures, wherein clinical data of a plurality of clinical trial sites and the obtained criteria for the clinical study may be further analyzed to determine clinical trial sites which may exceed target performance parameter measures of the obtained criteria. From various performance parameter measures, a ranking of the performance parameter measures can be derived wherein the ranking may be for at least one of clinical trial sites, payment amounts, study discontinuation decisions (namely, decisions as to whether or not a clinical study should be discontinued), and suitability of patients for the clinical study, etc.

Thereafter, once the first and second databases are created, a rules engine can be developed or built, which interfaces to the first and second electronic databases and to the clinical databases such as the workflow management system 210, the EPR 212 and the HIS 214, etc. This rules engine can act in evaluating the first and second databases to calculate the performance measures. The performance measures can be stored in a third database and/or output or imported. Further, the criteria for the clinical study may include at least one performance parameter, wherein performance parameter measures are derived for at least one performance parameter.

Finally, from this third database, a ranking of the performance measures can be derived, or the third database can be evaluated, for use in improving the clinical study. For example, the third database (or the performance measures themselves, not stored in a formal database) can be evaluated to derive a ranking of clinical trial sites, payment amounts, study discontinuation decisions, suitability of patients for the clinical study, etc.

Thus, an apparatus for improving a clinical study can include a first electronic database including criteria for the clinical study and a second electronic database including rules for calculating performance measures from the criteria and from the clinical data. The apparatus can include a rules engine, adapted to interface and evaluate the first and second databases and the clinical data to calculate the performance measures. Finally, a third database can be included for storing the performance measures, wherein a ranking of the performance measures is derivable from the third database for use in improving the clinical study.

Again, in this embodiment, the criteria of the clinical study can be included in the clinical study protocol. The clinical data may be obtained from at least one electronic healthcare database including at least one of those previously set forth. The criteria can include at least one of rules, values and thresholds. Further, the criteria for the clinical study may include at least one performance parameter, wherein performance parameter measures are derived/calculated for at least one performance parameter. In addition, the rules engine may be further adapted to interface with at least one electronic healthcare database including the clinical data, to evaluate the databases and calculate the performance measures/performance parameter measures. Additionally, the ranking may be used for at least one of ranking clinical trial sites, ranking payment amounts, ranking to make study discontinuation decisions, suitability of patients for the clinical study, etc.

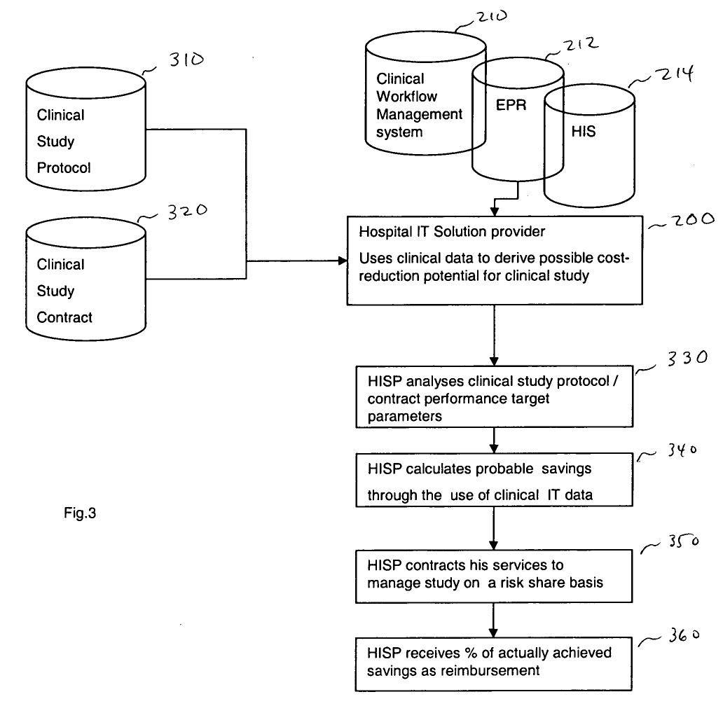

One example of risk-sharing business model for the HISP 200 in clinical studies is shown in FIG. 3. In such a model, the sponsor 220 and a HISP 200 may share the risk, (e.g. financial) success, or failure of a clinical study. In this one exemplary embodiment of the present application, the HISP 200 may receive clinical study protocol 310 and/or a clinical study contract 320 directly from the sponsor 220 (or alternatively from the CRO 230). The HISP 200 can then calculate performance measures and can contract/promise to increase the (e.g. financial) benefit (or increase other benefits such as reduced time or other potential advantages for example). The HISP 200 may then receive a certain percentage of the actual increase of the benefit (y % of the x increase in benefit). The risk of the HISP 200 is that it is working for little or even no payment, if it cannot realize the promised increased benefit. Further, the criteria for the clinical study may include at least one performance parameter, wherein performance parameter measures are calculated for at least one performance parameter.

Measures for increased benefit can include, for example, overall cost of the study, duration of the study, reliability or accuracy of the resulting data from the study (i.e., statistical significance of derived conclusions), etc. Overall cost of the study is a direct financial measure, whereas indirect financial benefits from a reduced study duration may depend on the accordingly achieved shortening of market entry time and thus increased revenue achieved by the product (drug, etc.) which is the subject of the clinical study.

An even more indirect benefit may be an increased statistical significance of the conclusion of the study. The desired conclusion most often is “the new medication is suitable for and improves the treatment of disease x”. As one non-limiting example, this conclusion may be derived from trying the medication on four patients only, for example, the probability of the observed positive outcome is a “false positive”, i.e., the medicate seemed to help in four patients, but does not help in the next 100 patients, is much higher than if the medication was tried on 1,000 patients and helped in 950 cases. Therefore, a good statistical significance reduces the probability of market introduction of the drug was in vane (for example, at very high promotional costs), and the drug has to be removed from the market.

Referring back to FIG. 3, the HISP 200, in this embodiment, re-analyzes the criteria (clinical study protocol, clinical study contract, target performance parameter measures etc.) as well as the clinical data, to calculate various performance/performance parameter measures which can be compared to, for example, the performance target parameters of element 330 of FIG. 3. From there, in element 340, the HISP 200 may calculate probable savings via its use of clinical IT data. Thereafter, in element 350, the HISP 200 may contract, based upon the calculated performance parameter measures and probable savings, to manage the clinical study, such as on a risk-sharing basis. Thereafter, the HISP 200 may receive a certain percentage of the actual achieved savings as a reimbursement, as set forth in element 360.

Thus, based upon the calculated performance parameter measures, the HISP 200 may contract to manage the clinical study. Further, a ranking may be derived from the calculated performance parameter measures, wherein the ranking is used for at least one of ranking clinical trial sites, ranking payment amounts, ranking to make study discontinuation decisions, suitability of patients for the clinical study, etc. The ranking of the performance parameter measures may be derived at predefined milestones during the clinical study for example, wherein the performance measures derived at each milestone may be compared with the threshold or threshold criteria and wherein the clinical study may be discontinued if threshold criteria are not met. Further, the contracting may include receiving a percentage of money, for example based upon the calculated performance parameter measures, a calculated potential savings, a percentage of money saved from the improvement, etc.

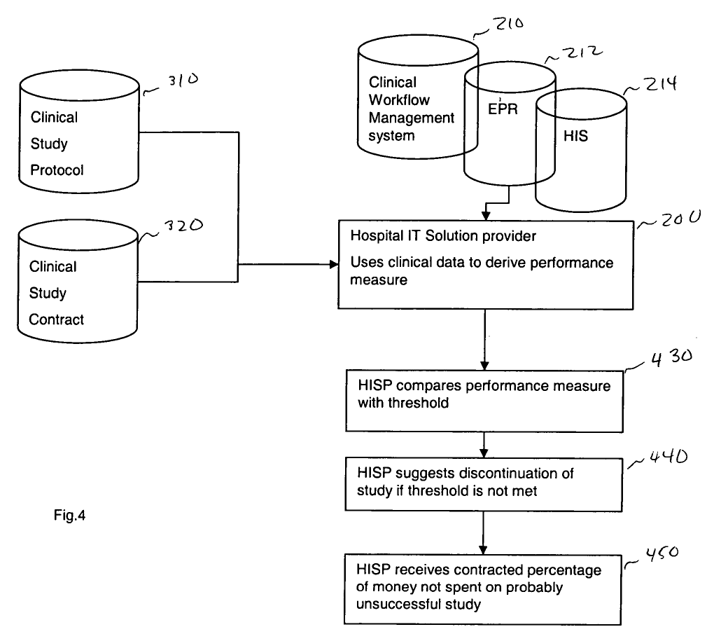

FIG. 4 illustrates one exemplary embodiment of a business model, wherein a portion of saved money is received, if a probably unsuccessful study is discontinued early. In this example, as shown in FIG. 4, at least one of the clinical study protocol 310 and clinical study contract 320 supplies the clinical study criteria to the HISP 200. The HISP 200 correlates the criteria obtained for the clinical study with clinical data from one or more of clinical workflow management system 210, EPR 212 and HIS 214, etc. to derive performance measures for improving the clinical study. The HISP 200 may then compare the performance measures with some type of threshold or target performance parameter measures as shown in element 430, wherein the criteria for the clinical study may include one or more of performance parameters, target performance parameter measures, rules, values and thresholds. Further, the criteria for the clinical study may include at least one performance parameter, wherein performance parameter measures are derived for at least one performance parameter.

As shown in element 440, the HISP 200 may then suggest or recommend discontinuation of the clinical study if one or more of the target performance parameter measures, rules, values and/or threshold criteria is not met. This discontinuation of a clinical study at a particular clinical trial site, for example, may result in a large reduction in losses or costs which may have been incurred if the study had been continued and unfavorable results were achieved. Thus, this can be a large cost savings to the sponsor 220 and thus the HISP 200 may receive a contracted percentage of money not spent on a probably unsuccessful study, as shown in element 450.

Each of the various embodiments discussed above can include the use of weighting factors. For example, the clinical study criteria obtained can include weighing factors, wherein the weighting factors may reflect a likelihood of the “criteria” to correlate with direct benefit, such as financial benefit, for example. The deriving of the performance measures may e based upon one or more weighting factors. With regard to performance parameters such as study duration, costs, study result reliability, major “criteria” which may help to influence these measures positively may include, but are not limited to:
Overall number of patients which can be enrolled in the study, respectively number of patients per time unit which can be enrolled;
Time-effectiveness of data collection and evaluation;
Compliance of investigator and patient with the study rules;
Experience/capability of the investigator to motivate patients for continued participation until the end of the study, and not drop out earlier;
claimed amount of compensation from investigator and patient, etc.

Often, these “criteria” cannot be measured directly, but must be deduced from other measurable parameters, and perhaps from a combination of other measurable parameters. Thus, the HISP 200 may, for example, build an empirical database on typical “dropout” rates of patients, wherein these rates might vary with investigation sites, patient's age, geography, etc. Thus, the HISP 200 can create a type of mathematical formula or weighting factors regarding the combining of several direct and indirect criteria into a prediction of probable benefit, such as probable financial benefit. Most likely, this formula will include a weighted sum or weighted product of the single criteria. Accordingly, an output ranking may be derived from the calculated performance parameter and a ranking may be based upon weighted determinations using the weighing factors.

Thus, from performance parameter measures, a ranking of the performance parameter measures can be derived. The ranking may be for at least one of clinical trial sites, payment amounts, study discontinuation decisions and suitability of patients for the clinical study.

It should be further noted that a level of guarantee of performance for at least one of a plurality of clinical trial sites, and/or for other clinical trials, may be provided based on calculated performance measures/performance parameter measures. A plurality of varying levels of guarantee may be provided for a plurality of clinical trial sites. This level of guarantee may be based upon weighted determinations, wherein weighting factors may include one of time for performing a clinical trial, quality and geographic location, etc.

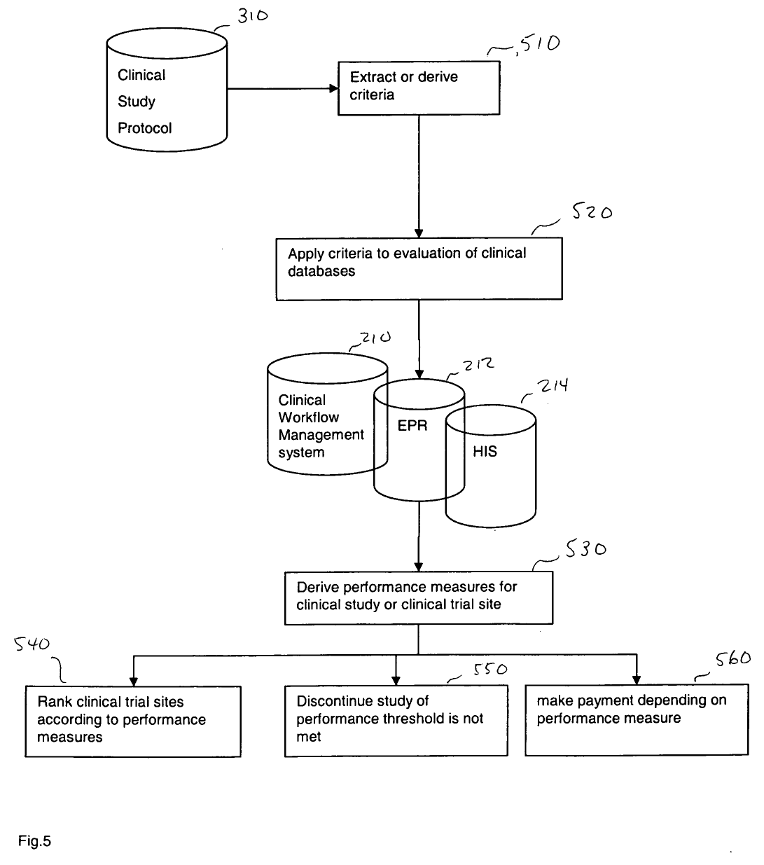

FIG. 5 illustrates an embodiment of a methodology of HISP 200 evaluation of performance parameters. Initially, the clinical study protocol criteria of the clinical study 310 are extracted, derived or obtained as shown in element 510 to FIG. 5. Thereafter, the criteria of the clinical study are applied or correlated, in some manner, to the evaluation of clinical data of clinical databases in step 520. These clinical databases, including clinical data, can include but are not limited to, clinical workflow management system 210, EPR 212, HIS 214, etc. Based upon some type of application/correlation of the criteria for the clinical study to the clinical data in the clinical databases, performance measures for the clinical study (including but not limited parameters for one or more clinical trial sites) are derived as shown in element 530. These performance measures can include measures of study duration and cost, study result reliability, etc., and can then be used to rank various clinical trial sites (for example) according to these performance measures as shown in step 540. The ranking of the clinical trial sites can indicate which clinical trial site(s) is best suited to perform a particular clinical study, for example, and these rankings can be output or provided to a sponsor 220, for example. Further, the criteria for the clinical study may include at least one performance parameter, wherein performance parameter measures are derived for at least one performance parameter.

Further, the performance parameter measures or performance measures can be used in the determination of whether or not the particular clinical study should be discontinued. For example, the derived performance parameter measures or performance measures can be compared to certain required thresholds (or target performance parameters obtained from the clinical study criteria), and a decision can be made in step 550 to discontinue a study if the performance threshold is not met.

The services of the HISP 200 may be contracted to obtain and manage a particular study, to derive the aforementioned ranking of clinical trial sites according to performance parameter measures or performance measures, to receive a contracted percentage of money not spent on a probable unsuccessful study, etc. Further, derived performance parameter measures or performance measures can be used to make payment, by a sponsor to a particular clinical trial site, patient, investigator, etc., based upon a performance parameter measure or parameter achieved as shown in element 560. The HISP 200 may then receive a percentage of money for deriving these particular performance parameter measures or performance measures.

As one non-limiting example of the methodology of one embodiment of the present application, a clinical study protocol (including clinical study criteria) may be for testing a new medication for hypertension. The target patient group may include patients between 20 and 50 years of age which have been diagnosed with hypertension for the first-time, and which have not been prescribed drugs for treating hypertension previously. This may be outlined in the clinical study criteria obtained/received by the HISP 200.

In such an exemplary embodiment, patients for the study may be divided into two groups of equal size, one group being given the new medication in the test and the other group being given conventional medication. As set forth in the criteria of the clinical study, the study first requires a whole body CT scan for each patient at the beginning of the study, excluding specific pathologies such as aortic malformations, etc. for the hypertension. Further information regarding the criteria of the clinical study may include an observation period for each patient for six months, wherein the development of blood pressure may be controlled weekly, for example. One thousand patients may be planned to be enrolled at three different clinical trial sites, for example. The cost for the study may be planned at “x” dollars and the targeted time frame for the study may be two years. The prognostic statistical significance for the study has been previously calculated to be 82%. Again, this information is preferably, in the example, part of the clinical study criteria obtained/received by the HISP 200.

In connection with an embodiment of the present application, the HISP 200 receives/obtains in some way, the criteria for a clinical study. The HISP 200 can then compare/correlate this criteria of the clinical study protocol with electronic healthcare database clinical IT databases of one or more clinical trial sites, regarding past performance of an investigator or investigation/clinical trial site. The HISP 200 can then evaluate, utilizing the criteria and clinical data, to identify the best performing investigators or investigation/clinical trial sites. For example, the HISP 200 can review the EPR 212 to identify how many suitable patients have been treated in this particular institution (clinical trial site or investigation site) over a period of time, e.g. the past two years. A research table of the clinical workflow management system 210 may further be analyzed to determine which of the institutions or clinical trial sites include the required whole body CT scanner. Further, the EPR 212 can be used to investigate which clinical trial site is experienced in that particular procedure by counting or reviewing the number of such exams previously done in the past, for example. The HISP 200 database of patient dropout rates for this patient group may then be analyzed.

From this analysis, the HISP 200 may conclude, for example, that the study duration is reducible by six months, the overall cost is reducible by 10% and at the same time the statistical significance of 89% is achievable, as the exemplary calculated performance parameter measures for example. These performance parameter measures can be determined for a single clinical trial site or can be ranked for a plurality of clinical trial sites, wherein different performance parameter measures can be calculated for each trial site, namely different values of performance parameter measures.

From this information, the HISP 200 can then propose these improvements to the sponsor 220 of the clinical study, with a condition of a contract to the top three, for example, most suitable investigators or clinical trial or investigation sites. Plus, for particular performance parameter measures calculated, a plurality of investigation/clinical trial sites may be ranked which can achieve the calculated or satisfactory performance parameter measures. The sponsor 220 in turn can calculate the possible financial benefit if these improvements are realized.

Although a formula for calculating the risk-shared payment may depend on the actually achieved stated improvements, this risk-shared payment may be negotiated and the HISP 200 contracted on this basis. During the study, the HISP 200 may then evaluate multiple clinical trial sites, partners, etc. by constantly re-evaluating study-relevant patient data and/or the EPR 212, for example, of enrolled patients; and by taking additional measures when actual performance is not as good as expected. Thus, the performance parameter measures can be recalculated based upon the monitored information for at least one clinical trial site, and/or a re-ranking determined. Further, a guaranteed level of performance can be provided for at least one of a plurality of clinical trial sites for the clinical trial based on the recalculated performance parameter measures and/or the re-ranking, based upon the monitored information.

Any of the aforementioned methods may be embodied in the form of a system or device, including, but not limited to, any of the structure for performing the methodology illustrated in the drawings.

Further, any of the aforementioned methods may be embodied in the form of a program. The program may be stored on a computer readable media and is adapted to perform any one of the aforementioned methods when run on a computer device (a device including a processor). Thus, the storage medium or computer readable medium, is adapted to store information and is adapted to interact with a data processing facility or computer device to perform the method of any of the above mentioned embodiments.

The storage medium may be a built-in medium installed inside a computer device main body or a removable medium arranged so that it can be separated from the computer device main body. Examples of the built-in medium include, but are not limited to, rewriteable involatile memories, such as ROMs and flash memories, and hard disks. Examples of the removable medium include, but are not limited to, optical storage media such as CD-ROMs and DVDs; magneto-optical storage media, such as MOs; magnetism storage media, such as floppy disks (trademark), cassette tapes, and removable hard disks; media with a built-in rewriteable involatile memory, such as memory cards; and media with a built-in ROM, such as ROM cassettes.

Exemplary embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A method of improving a clinical study, comprising:
obtaining criteria for the clinical study;
comparing clinical data to the obtained criteria using a computer device; and
deriving, using the computer device, performance measures based upon the comparisons, wherein the derived performance measures are usable to improve the clinical study.

2. The method of claim 1, wherein the criteria for the clinical study includes a clinical study protocol.

3. The method of claim 1, wherein the criteria for the clinical study includes at least one performance parameter, and wherein at least one performance parameter measure is derived for at least one performance parameter.

4. The method of claim 2, wherein the clinical study protocol includes at least one performance parameter, and wherein at least one performance parameter measure is derived for at least one performance parameter.

5. The method of claim 1, wherein the clinical data includes data from a plurality of previously conducted clinical trials.

6. The method of claim 5, wherein the clinical data is stored in at least one database.

7. The method of claim 1, wherein the clinical study protocol includes at least one target performance parameter measure, and wherein at least one performance parameter measure is compared to the at least one target performance parameter measure.

8. The method of claim 7, wherein clinical data of a plurality of clinical trial sites and the obtained criteria are further compared to determine which performance parameter measures of which clinical trial sites exceed the at least one target performance parameter measure of the obtained criteria.

9. The method of claim 8, further comprising providing names of the clinical trial sites, determined to exceed the at least one target performance parameter measure of the obtained criteria, to a sponsor.

10. The method of claim 3, further comprising deriving, from the performance parameter measures, a ranking of the performance parameter measures, and wherein the ranking is for at least one of clinical trial sites, payment amounts, study discontinuation decisions and suitability of patients for the clinical study.

11. The method of claim 10, further comprising providing names of the clinical trial sites, determined from the rankings, to a sponsor.

12. The method of claim 3, further comprising calculating potential savings from the derived performance parameter measures for improving the clinical study.

13. The method of claim 8, further comprising calculating potential savings from using the clinical trial sites determined to exceed the at least one target performance parameter measure of the obtained criteria.

14. The method of claim 9, further comprising calculating potential savings from using the clinical trial sites determined to exceed the at least one target performance parameter measure of the obtained criteria.

15. The method of claim 10, further comprising calculating potential savings from using the clinical trial sites determined to exceed the at least one target performance parameter measure of the obtained criteria.

16. The method of claim 12, further comprising contracting for performance of the clinical study based upon the calculated potential savings.

17. The method of claim 8, further comprising calculating potential advantages obtained from using the clinical trial sites determined to exceed the at least one target performance parameter measure of the obtained criteria.

18. The method of claim 9, further comprising calculating potential advantages obtained from using the clinical trial sites determined to exceed the at least one target performance parameter measure of the obtained criteria.

19. The method of claim 10, further comprising calculating potential advantages obtained from using the clinical trial sites determined to exceed the at least one target performance parameter measure of the obtained criteria.

20. The method of claim 17, wherein the potential advantages include at least one of reduced time and cost saving.

21. The method of claim 18, wherein the potential advantages include at least one of reduced time and cost saving.

22. The method of claim 19, wherein the potential advantages include at least one of reduced time and cost saving.

23. The method of claim 13, further comprising contracting for performance of the clinical study based upon the calculated potential savings.

24. The method of claim 14, further comprising contracting for performance of the clinical study based upon the calculated potential savings.

25. The method of claim 15, further comprising contracting for performance of the clinical study based upon the calculated potential savings.

26. The method of claim 20, further comprising contracting for performance of the clinical study on a risk sharing basis, based upon at least one of the potential advantages.

27. The method of claim 21, further comprising contracting for performance of the clinical study on a risk sharing basis, based upon at least one of the potential advantages.

28. The method of claim 22, further comprising contracting for performance of the clinical study on a risk sharing basis, based upon at least one of the potential advantages.

29. The method of claim 23, further comprising contracting for payment based upon the calculated potential savings, the payment being based upon a percentage of an achieved saving.

30. The method of claim 24, further comprising contracting for payment based upon the calculated potential savings, the payment being based upon a percentage of an achieved saving.

31. The method of claim 25, further comprising contracting for payment based upon the calculated potential savings, the payment being based upon a percentage of an achieved saving.

32. The method of claim 12, further comprising contracting for payment based upon the calculated potential savings, the payment being based upon a percentage of an achieved saving.

33. The method of claim 13, further comprising contracting for payment based upon the calculated potential savings, the payment being based upon a percentage of an achieved saving.

34. The method of claim 14, further comprising contracting for payment based upon the calculated potential savings, the payment being based upon a percentage of an achieved saving.

35. The method of claim 1, wherein the clinical data is from at least one electronic health care database.

36. The method of claim 35, wherein the at least one electronic health care database includes at least one of electronic patient records, a clinical workflow management system, a hospital information system, a laboratory information system, a radiology information system, a picture archiving and communication system and information technology of a physician's office.

37. The method of claim 1, further comprising:
obtaining the clinical data from at least one electronic health care database.

38. The method of claim 37, wherein the at least one electronic health care database includes at least one of electronic patient records, a clinical workflow management system, a hospital information system, a laboratory information system, a radiology information system, a picture archiving and communication system and information technology of a physician's office.

39. A method of improving a clinical study, comprising:
creating a first electronic database of criteria for the clinical study;
creating a second electronic database of rules for calculating performance measures from the criteria and from clinical data; and
evaluating the first and second databases and the clinical data to calculate the performance measures; and
storing the performance measures in a third database; and
deriving, from the third database, a ranking of the performance measures for use in improving the clinical study.

40. The method of claim 39, wherein the criteria for the clinical study includes a clinical study protocol.

41. The method of claim 39, wherein the criteria for the clinical study includes at least one performance parameter, and wherein at least one performance parameter measure is calculated for at least one performance parameter.

42. The method of claim 40, wherein the clinical study protocol includes at least one performance parameter, and wherein at least one performance parameter measure is calculated for at least one performance parameter.

43. The method of claim 39, wherein the clinical data is obtained from at least one electronic health care database.

44. The method of claim 43, wherein the at least one electronic health care database includes at least one of electronic patient records, a clinical workflow management system, a hospital information system, a laboratory information system, a radiology information system, a picture archiving and communication system and information technology of a physician's office.

45. The method of claim 39, wherein the criteria includes at least one of rules, values, and thresholds.

46. The method of claim 43, wherein the evaluating includes building a rules engine, adapted to interface with the first and second databases and with at least one electronic health care database including the clinical data, to evaluate the databases and calculate the performance measures.

47. The method of claim 46, wherein the ranking is for at least one of clinical trial sites, payment amounts, study discontinuation decisions and suitability of patients for the clinical study.

48. A method, comprising:
creating an electronic database of rules for calculating performance measures from criteria of a clinical study and from clinical data; and
calculating the performance measures from the database of rules, the criteria of the clinical study and the clinical data; and
contracting, based upon the calculated performance measures, to manage the clinical study.

49. The method of claim 48, wherein the criteria for the clinical study includes a clinical study protocol.

50. The method of claim 48, wherein the criteria for the clinical study includes at least one performance parameter, and wherein at least one performance parameter measure is calculated for at least one performance parameter.

51. The method of claim 49, wherein the clinical study protocol includes at least one performance parameter, and wherein at least one performance parameter measure is calculated for at least one performance parameter.

52. The method of claim 48, wherein the clinical data is obtained from at least one electronic health care database.

53. The method of claim 52, wherein the at least one electronic health care database includes at least one of electronic patient records, a clinical workflow management system, a hospital information system, a laboratory information system, a radiology information system, a picture archiving and communication system and information technology of a physician's office.

54. The method of claim 48, wherein the criteria includes at least one of rules, values, and thresholds.

55. The method of claim 52, wherein the calculating includes building a rules engine, adapted to interface with the electronic database and with at least one electronic health care database including the clinical data, to calculate the performance parameter measures.

56. The method of claim 55, wherein a ranking is derived from the calculated performance measures and wherein the ranking is used for at least one of ranking clinical trial sites, ranking payment amounts and ranking to make study discontinuation decisions.

57. The method of claim 1, wherein the deriving of the performance measures is performed at predefined milestones during the clinical study.

58. The method of claim 57, wherein the performance measures derived at each milestone, are compared with threshold criteria.

59. The method of claim 58, wherein the clinical study is discontinued if the threshold criteria are not met.

60. A device for implementing the method of claim 1.

61. A program, adapted to perform the method of claim 1, when executed on a computer.

62. A computer readable medium, storing the program of claim 61.

63. The method of claim 1, further comprising:
contracting such that a percentage of money, saved from the improvement, is received.

64. The method of claim 3, wherein the deriving of the performance parameter measures is performed at predefined milestones during the clinical study.

65. The method of claim 64, wherein the performance parameter measures derived at each milestone, are compared with threshold criteria.

66. The method of claim 65, wherein the clinical study is discontinued if the threshold criteria are not met.

67. The method of claim 39, wherein the deriving of the ranking of the performance measures is performed at predefined milestones during the clinical study.

68. The method of claim 67, wherein the rankings derived at each milestone, are compared with threshold criteria.

69. The method of claim 68, wherein the clinical study is discontinued if the threshold criteria are not met.

70. A device for implementing the method of claim 39.

71. A program, adapted to perform the method of claim 39, when executed on a computer.

72. A computer readable medium, storing the program of claim 71.

73. The method of claim 39, further comprising:
contracting such that a percentage of money, saved from the improvement, is received.

74. The method of claim 41, wherein the deriving of the performance parameter measures is performed at predefined milestones during the clinical study.

75. The method of claim 74, wherein the performance parameter measures derived at each milestone, are compared with threshold criteria.

76. The method of claim 75, wherein the clinical study is discontinued if the threshold criteria are not met.

77. The method of claim 56, wherein a ranking of the performance measures is calculated at predefined milestones during the clinical study.

78. The method of claim 77, wherein the rankings derived at each milestone, are compared with threshold criteria.

79. The method of claim 78, wherein the clinical study is discontinued if the threshold criteria are not met.

80. A device for implementing the method of claim 48.

81. A program, adapted to perform the method of claim 48, when executed on a computer.

82. A computer readable medium, storing the program of claim 81.

83. The method of claim 48, wherein the contracting includes receiving a percentage of money, saved based upon the calculated performance measures.

84. The method of claim 50, wherein the calculating of the performance measures is performed at predefined milestones during the clinical study.

85. The method of claim 84, wherein the performance measures calculated at each milestone, are compared with threshold criteria.

86. The method of claim 85, wherein it is recommended that the clinical study be discontinued if the threshold criteria are not met.

87. The method of claim 1, wherein the obtained criteria includes quality and performance parameters, and wherein quality and performance parameter measures are derived.

88. The method of claim 39, wherein the obtained criteria includes quality and performance parameters and wherein quality and performance parameter measures are calculated.

89. The method of claim 48, wherein the obtained criteria includes quality and performance parameters and wherein quality and performance parameter measures are calculated.

90. The method of claim 39, wherein clinical data of a plurality of clinical trial sites and the obtained criteria are further analyzed to determine clinical trial sites which may exceed target performance parameter measures of the obtained criteria.

91. The method of claim 90, further comprising providing names of the clinical trial sites, determined to exceed target performance parameter measures of the obtained criteria, to a sponsor.

92. The method of claim 48, wherein clinical data of a plurality of clinical trial sites and the obtained criteria are further analyzed to determine clinical trial sites which may exceed target performance parameter measures of the obtained criteria.

93. The method of claim 92, further comprising providing names of the clinical trial sites, determined to exceed target performance parameter measures of the obtained criteria, to a sponsor.

94. The method of claim 1, wherein the criteria obtained includes weighting factors.

95. The method of claim 94, wherein the deriving is based upon weighted determinations from the weighting factors.

96. The method of claim 39, wherein the criteria includes weighting factors.

97. The method of claim 96, wherein the ranking is based upon weighted determinations from the weighting factors.

98. The method of claim 39, further comprising:
monitoring at least one clinical trial site during at least one clinical trial; and
re-ranking based upon the monitored information.

99. The method of claim 98, further comprising:
providing a level of guarantee of performance for at least one of the plurality of the clinical trial sites, for the desired clinical trial, based on the determinations.

100. The method of claim 99, wherein a plurality of varying levels of guarantee are provided for a plurality of the clinical trial sites.

101. The method of claim 100, wherein the level of guarantee is based upon weighted determinations.

102. The method of claim 101, wherein the weighting factors include at least one of time for performing a clinical trial, quality, and geographic location.

103. The method of claim 48, wherein the criteria includes weighting factors.

104. The method of claim 103, wherein a ranking is derived from the calculated performance measures, and wherein the ranking is based upon weighted determinations using the weighting factors.

105. The method of claim 48, further comprising:
monitoring at least one clinical trial site during at least one clinical trial; and
re-calculating the performance measures based upon the monitored information.

106. The method of claim 105, further comprising:
providing a level of guarantee of performance for at least one of the plurality of the clinical trial sites, for the clinical trial, based on the re-calculated performance measures.

107. The method of claim 106, wherein a plurality of varying levels of guarantee are provided for a plurality of the clinical trial sites.

108. The method of claim 107, wherein the level of guarantee is based upon weighted determinations.

109. The method of claim 108, wherein the weighting factors include at least one of time for performing a clinical trial, quality, and geographic location.

110. An apparatus for improving a clinical study, comprising:
a first electronic database including criteria for the clinical study;
a second electronic database including rules for calculating performance measures from the criteria and from clinical data;
a rules engine, adapted to interface with and evaluate the first and second databases and the clinical data to calculate the performance measures; and
a third database for storing the calculated performance measures, wherein a ranking of the performance measures is derivable from the third database for use in improving the clinical study.

111. The apparatus of claim 110, wherein the criteria for the clinical study includes a clinical study protocol.

112. The apparatus of claim 110, wherein the criteria for the clinical study includes at least one performance parameter, and wherein at least one performance parameter measure is calculated.

113. The apparatus of claim 111, wherein the clinical study protocol includes at least one performance parameter, and wherein at least one performance parameter measure is calculated.

114. The apparatus of claim 110, wherein the at least one electronic health care database includes at least one of electronic patient records, a clinical workflow management system, a hospital information system, a laboratory information system, a radiology information system, a picture archiving and communication system and information technology of a physician's office.

115. The apparatus of claim 110, wherein the criteria includes at least one of rules, values, and thresholds.

116. The apparatus of claim 110, wherein the rules engine, is further adapted to interface with at least one electronic health care database including the clinical data, to evaluate the databases and calculate the performance parameter measures.

117. The apparatus of claim 110, wherein the ranking is used for at least one of ranking clinical trial sites, ranking payment amounts and ranking to make study discontinuation decisions.

118. An apparatus for improving a clinical study, comprising:
means for forming a first electronic database including criteria for the clinical study and for forming a second electronic database including rules for calculating performance measures from the criteria and from clinical data;
means for forming a rules engine for interfacing with and evaluating the first and second databases and the clinical data to calculate the performance measures, wherein the means for forming forms a third database including the calculated performance measures; and
means for ranking of the performance measures of the third database, wherein the ranking is for use in improving the clinical study.

119. The apparatus of claim 118, wherein the criteria for the clinical study includes a clinical study protocol.

120. The apparatus of claim 118, wherein the criteria for the clinical study includes at least one performance parameter, and wherein at least one performance parameter measure is calculated.

121. The apparatus of claim 119, wherein the clinical study protocol includes at least one performance parameter, and wherein at least one performance parameter measure is calculated.

122. The apparatus of claim 118, wherein the clinical data is obtained from at least one electronic health care database.

123. The apparatus of claim 122, wherein the at least one electronic health care database includes at least one of electronic patient records, a clinical workflow management system, a hospital information system, a laboratory information system, a radiology information system, a picture archiving and communication system and information technology of a physician's office.

124. The apparatus of claim 118, wherein the criteria includes at least one of rules, values, and thresholds.

125. The apparatus of claim 118 wherein the rules engine is further adapted to interface with at least one electronic health care database including the clinical data, to evaluate the databases and calculate the performance parameter measures.

126. The apparatus of claim 118, wherein the ranking is used for at least one of ranking clinical trial sites, ranking payment amounts and ranking to make study discontinuation decisions.

127. An apparatus, comprising:
means for creating an electronic database of rules for calculating performance measures from criteria of a clinical study and from clinical data; and
means for calculating the performance measures from the database of rules, the criteria of the clinical study and the clinical data, wherein, based upon the calculated performance measures, a contract to manage the clinical study is negotiable.

128. The apparatus of claim 127, wherein the criteria for the clinical study includes a clinical study protocol.

129. The apparatus of claim 127, wherein the criteria for the clinical study includes at least one performance parameter, and wherein at least one performance parameter measure is calculated.

130. The apparatus of claim 128, wherein the clinical study protocol includes at least one performance parameter, and wherein at least one performance parameter measure is calculated.

131. The apparatus of claim 127, wherein the clinical data is obtained from at least one electronic health care database.

132. The apparatus of claim 131, wherein the at least one electronic health care database includes at least one of electronic patient records, a clinical workflow management system, a hospital information system, a laboratory information system, a radiology information system, a picture archiving and communication system and information technology of a physician's office.

133. The apparatus of claim 127, wherein the criteria includes at least one of rules, values, and thresholds.

134. The apparatus of claim 131, wherein the means for calculating builds a rules engine, adapted to interface with the electronic database and with at least one electronic health care database including the clinical data, for calculating the performance parameter measures.

135. The apparatus of claim 134, wherein the means for calculating is further for deriving a ranking from the calculated performance parameter measures, and wherein the ranking is for at least one of clinical trial sites, payment amounts and study discontinuation decisions.

136. An apparatus improving a clinical study, comprising:
means for obtaining criteria for the clinical study;
means for comparing clinical data and the obtained criteria; and
means for deriving performance measures based upon the comparisons, wherein the derived performance measures are usable to improve the clinical study.

137. The apparatus of claim 136, wherein the criteria includes study protocol of the clinical study.

138. The apparatus of claim 136, wherein the criteria for the clinical study includes at least one performance parameter, and wherein at least one performance parameter measure is derived.

139. The apparatus of claim 137, wherein the clinical study protocol includes at least one performance parameter, and wherein at least one performance parameter measure is derived.

140. The apparatus of claim 136, wherein the clinical data is obtained from at least one electronic health care database.

141. The apparatus of claim 140, wherein the at least one electronic health care database includes at least one of electronic patient records, a clinical workflow management system, a hospital information system, a laboratory information system, a radiology information system, a picture archiving and communication system and information technology of a physician's office.

142. The apparatus of claim 136, wherein the criteria includes at least one of rules, values, and thresholds.

143. The apparatus of claim 138, wherein the means for comparing builds a rules engine, adapted to interface with the means for obtaining criteria and with at least one electronic health care database including the clinical data, for deriving the performance parameter measures.

144. The apparatus of claim 143, wherein the means for deriving further derives, from the performance parameter measures, a ranking of the performance parameter measures, and wherein the ranking is for at least one of clinical trial sites, payment amounts, study discontinuation decisions and suitability of patients for the clinical study.
